(19) United States
(12) Patent Application Publication
(10) Pub. No.: US 2024/0267330 A1
(43) Pub. Date: Aug. 8, 2024

(54) METHODS AND SYSTEMS FOR MANAGING AND MONITORING NETWORK RESOURCES FOR ENSURING QUALITY OF SERVICE FOR ENTERPRISE USERS IN THE ACCESS NETWORKS

(71) Applicant: Woofy Inc., Pasay (PH)

(72) Inventors: Rene Maria Buniel Dos Remedios, Muntinlupa (PH); Melvin Simon Pangan, Paranaque (PH); Carlo Miguel Echavez Adajar, Muntinlupa (PH)

(73) Assignee: Woofy Inc., Pasay (PH)

(21) Appl. No.: 18/107,012

(22) Filed: Feb. 8, 2023

(51) Int. Cl. H04L 47/12; H04L 43/0882; H04L 43/12

(52) U.S. Cl. CPC H04L 47/12; H04L 43/0882; H04L 43/12

(57) ABSTRACT

In this invention, we seek to optimize end user Internet connection performance. We focus specifically on enterprise end users to narrow the scope of the problem without sacrificing the generality of the approach. To optimize Internet connections for enterprise end users, the network connections need to be optimized from the ISP Internet Edge through the Enterprise Gateway connection all the way up to the individual enterprise end user. The only way to ensure that an end user can receive any network traffic, uninterrupted and with low latency, is to ensure that there is no congestion between the source and end user nodes. Non-congestion is a sufficient and necessary condition to ensure that a network provider can deliver on their enterprise Quality of Service (QOS) guarantees. This invention presents systems and methods that can ensure non-congestion between source and end user nodes.

While the Tier 1 and Tier 2 Internet backbone providers closely approximate the ideal of non-congested network transports, our invention focuses on the Internet Service Providers (ISP) and the enterprise distribution networks that extend Internet connections from the Tier 1 and Tier 2 Internet backbone providers to the end users. Internet connections are measured in terms of the Internet bandwidth, or bits per second of access that the Internet end user has to the Tier 1 or Tier 2 backbones. Bandwidth is sold by the ISPs.

Most bandwidth customer provisioning practices involve overprovisioning of available bandwidth at the enterprise gateway connection to ensure that end users will have unlimited resources for data transfer to or from the Internet during typical usage. This overprovisioned bandwidth can be quite costly for service providers and for end users. This will also result in underutilized, inefficient networks.

In networks where the bandwidth is under-provisioned, contention becomes an issue, especially during peak consumption periods. Users on the network will experience regular packet loss and data retransmission, resulting in higher connection latency and degraded user experience during times of heavy network usage. Many strategies have been developed to address problems caused by under-provisioned networks. Traffic priority mechanisms have been implemented in the network protocols. Traffic prioritization devices are used to ensure that high priority traffic will always come first. Optimization methods like adaptive queue management approaches can ensure fair usage of available capacity. New protocols like the QUIC protocol have been invented to mitigate inefficiencies in TCP due to data retransmission. QUIC also allows higher throughputs by allowing parallel data transmission between end points. However, none of these approaches fully solve the issues caused by under-provisioned bandwidth.

This invention proposes methods and systems that will allow ISPs and Enterprise Network managers to provision sufficient network bandwidth for individual end users in order that every end user has sufficient provisioned capacity based on the agreed upon Quality of Service (QOS) for every user. This invention ensures that enterprise users will always get their agreed QoS for as long as there is no congestion at the enterprise gateway connection. The invention includes Feedback Control Mechanisms (FCMs) that ensure that Internet traffic at the enterprise gateway connection point and at the ISP service delivery edge will be uncongested. This will result in optimally provisioned Internet bandwidth service for each enterprise end user, for the enterprise as a whole, and for the Internet service provider, avoiding under-provisioning and presenting minimal overprovisioning.

The methods and systems described in this document will allow the ISP or a designated Enterprise Network manager with access to the ISP provisioning system to control bandwidth allocation to end users on the network via a subscription bandwidth allowance per end user device rather than a subscription bandwidth for the entire enterprise customer.

In this invention, the bandwidth usage of the single enterprise end user is monitored through a FCM that ensures that the allocated bandwidth for the individual end user is delivered independently of any other end user on the enterprise network. A second FCM ensures that the enterprise is provisioned with enough bandwidth to allow each independent end user connection to be non-congested. These mechanisms ensure a non-congested Quality of Service (QOS) for the enterprise end user.

Bandwidth consumed by the totality of enterprises is then managed by a third FCM to ensure that the total consumption of bandwidth by all enterprise customers does not exceed the bandwidth on the Internet edge of the ISP. The FCM allows the ISP to adjust the available bandwidth at the Internet Edge to ensure any site requiring more bandwidth can maintain activity at a non-congested state.

The methods and systems of this invention breakup and simplify feedback control loops to ensure that at any level on the network, users will not experience congestion and therefore no contention of resources. The attainment of non-congestion on any network is sufficient and necessary for improving user experience and achieving a level of service to end users that is promised by the service providers (QOS guarantee).

This invention is a general invention and can address residential and consumer end user experience, but to have a more manageable scope, we focus this invention on ensuring the quality of service of Internet end users located on sites with many end users connected to a single network such as enterprises, schools, public institutions, residential buildings, and other large Internet users.

### CROSS REFERENCE TO RELATED APPLICATIONS

This application acknowledges the benefits of U.S. Pat. No. 7,599,290 entitled “Methods and Systems for Providing Quality of Service in Packet based Core Transport Networks” by Rene Dos Remedios, et. al. filed on Aug. 11, 2006 and patented on Oct 6, 2009 and U.S. Pat. No. 6,765,873 entitled “Connections Bandwidth Right Sizing Based On Network Resources Occupancy Monitoring by Fichou, et. al. filed on Jun. 29, 2000 and patented on Jul. 20. 2004, and U.S. Pat. No. 6,931,011 B2 entitled “Methods And Systems For Bandwidth Management In Packet Data Networks” by Giacopelli, et. al. filed on Jan. 31, 2001 and patented on Aug. 16, 2005, the disclosure of which are incorporated herein by reference in its entirety.

### BACKGROUND OF THE INVENTION

Internet Bandwidth provisioning is done at the beginning of an enterprise customer's subscription to an ISP, where they typically choose a subscription plan based on how much the enterprise customer can afford to pay and how much they feel they need. While ideally purchasing excess resources to ensure that all the enterprise users will always have available resources for use would be a common choice, often this comes at an excessively high price. In many cases, because of economic reasons, enterprise networks are under-provisioned with bandwidth. When many users access an under-provisioned enterprise network, the bandwidth resources will become insufficient to serve all the users.

This becomes even more apparent in large enterprise networks, where many devices are constantly connected to the network. While there are some cases where not much bandwidth is consumed by the applications common in an enterprise such as email applications, there are also many common cases where much bandwidth is consumed. Applications such as video streaming, video calls, or file downloads require that the network maintain a state of non-congestion to avoid the processes being interrupted or packets being dropped.

It is also very common for computers and other devices on the enterprise network to require security and application updates. Some applications are designed to run updates in the background, consuming as much unused bandwidth as possible to ensure quick updates. While the impact of this may not seem as noticeable for single computers on small networks, the problem compounds in enterprise networks where you can have dozens to hundreds of computers connected to the same enterprise network. An example of this type of program is the Background Intelligent Transfer Service (BITS) used by Microsoft to keep programs up to date. This program performs updates on the applications and on the operating system by using all available free network capacity to download needed update files. Since it is designed to run in the background, the user running a computer with BITS will not notice its impact on the performance of their own applications, but it can add considerable additional load to the rest of the enterprise network. As the size of operating systems and applications approach several Gigabytes, software updates have become a considerable source of network traffic on enterprise networks.

A common approach to mitigate congestion when there is traffic generated by multiple applications on the network is to prioritize traffic by application type or end users. There are many methods of doing this. A simple approach is to set the type of service (TOS) bits in the IP header and enable the routers to prioritize traffic based on the TOS bits. More complex approaches allow switches, routers, or gateway devices to classify traffic based on protocols, applications, users, source and destination addresses, etc. and prioritize traffic based on any number of prioritization rules. Some solutions even use deep packet inspection to classify traffic based on the traffic payload content. These approaches can be very costly in terms of equipment requirements and even more costly in terms of the technical personnel required to implement and maintain the systems. It is worth noting that as most internet traffic shifts to encrypted transports like QUIC, many of these traffic classification approaches will no longer work in the future.

Background traffic can be scheduled or even suppressed depending on policies implemented by the enterprise. Device management systems can schedule updates during off peak hours or can even freeze software versions preventing automatic updates. Supervisors can then schedule updates only when they feel it is necessary. While optimizing the network capacity, scheduling and delaying updates can create significant security issues.

Another common approach to optimizing network performance is the optimization of the buffer queue behavior. Buffers or queues are a necessary mechanism for the proper operation of all network devices. Sub-optimal strategies result in inefficient queue management that is commonly referred to as “bufferbloat”. Optimizing queue management can result in throughput and latency improvements in congested networks but will not address the underlying congestion. In other words, it can improve performance for some at the expense of others.

A major shortcoming of most network performance optimization approaches is most of them do not address the fundamental cause of degraded network performance, i.e., network congestion. These approaches also become more difficult to manage when the workforce expands, and new employees are hired, or new devices are added to the network. Traffic types increase and many more resources need to be managed. Placing the burden of bandwidth provisioning, shaping, prioritization and monitoring on the enterprise can often result in insufficient solutions that, while addressing some issues, can lead to greater costs or unstable solutions.

### BRIEF SUMMARY OF THE INVENTION

Our invention presents systems and methods to prevent congestion for a plurality of users on the enterprise network to ensure sufficient Quality of Service (QOS) as per agreement with the Internet Service Provider (ISP) by shifting the point of bandwidth management from the Enterprise customer network gateway device to the enterprise end user devices. This invention effects control of the bandwidth at the enterprise gateway, by controlling the bandwidth consumption of individual enterprise end users. In addition, data taken from active probes on the customer network directly connected to the customer gateway device as well as monitoring on the Internet Edge gateway will be used to manage the overall network by ensuring non-congestion at all points of the network.

The present invention relates to systems and methods for monitoring and allocating resources to individual devices on the customer network while simultaneously giving them the best possible user experience with regards to resource availability. This invention aims to do so via the use of individually provisioned bandwidth, to which management of the customer network has control over with regards to how many individual devices and how much bandwidth shall be allocated to each device, dictating the QoS parameters for each end user device. The QoS of the device is determined by how the device is provisioned at its MaxRate and MinRate referring respectively to the maximum amount of bandwidth an end user can use and the minimum amount of bandwidth always available to an end user.

For this invention, the basic structure of the network is comprised of the following systems:
1. A subscriber management system where users are required to register their devices to connect to the Internet.
2. An access controller (AC) which acts as an Internet gateway device for the enterprise network and which contains device parameters for onsite enterprise user devices, which are used for device authentication and user access control. In addition, the AC contains provisioned end user subscription allowance parameters, the MaxRate and MinRate. The AC is provisioned with bandwidth at the ACMaxRate, which is the maximum amount of bandwidth that an AC can provide to all end users connected to the AC.

ACs located at the enterprise network act as a part of the FCM that maintains the bandwidth allocation depending on the end user subscription allowance parameters. The AC may throttle traffic of individual users depending on whether they have exceeded the bandwidth allocated to their registered package. Similarly, it is responsible for managing the traffic during times when the AC interface network traffic reaches the ACMaxRate and no longer has resources to allocate to the users onsite. The AC lowers the MaxRate of users connected to the AC until the MinRate so that users can still connect to the internet at a reduced rate. Once the system returns to a state of non-congestion, i.e., the aggregate traffic no longer exceeds the ACMaxRate, the system reverts its throttling policies and allows users to achieve their subscription MaxRate. The system time constant of the previous process is typically only a few seconds and end users will normally not detect a change in their user experience. A separate feedback control mechanism controlled from a separate Edge Controller works to keep the ACMaxRate always above the aggregate traffic on the AC. Since each end user is limited to a its bandwidth Maxrate, this prevents end users from taking over excess bandwidth that is meant for use by other end users. This prevents the process commonly called bandwidth “hogging” which is a very common occurrence in many enterprise networks. At the same time each end user will always be guaranteed a minimum amount of bandwidth, the MinRate, which will always ensure that the end user can always access the Internet.
3. An Internet Edge Router (ER) that has a network interface facing the enterprise customers and grants access to the Internet to enterprise customers. The capacity of the enterprise network interface can be adjusted by the EC. The upstream interface of the ER is connected to a Tier 1 or Tier 2 service provider, and it is assumed that the contracted Internet capacity of the upstream interface is always greater than the downstream enterprise facing capacity. This is possible because upstream internet capacities are connected to high-speed interfaces and the Internet usage on the upstream interface can be billed at a “pay per-use” basis or a “peak bandwidth” basis. The contracted “peak bandwidth” of the upstream must always be greater than the total enterprise bandwidth usage. We assume that Tier 1 or Tier 2 internet service providers are uncongested.

Similarly, the Internet Edge functions as a controller for the aggregate network of customer sites. Traffic from all ACs to and from sites on the network route through the Internet Edge to allow Internet Access to users on all sites.
4. An Access Control Manager (ACM) that stores end user subscription allowance parameters and adjusts the end user subscription allowance parameters on the onsite ACs. The ACM also stores end user parameters that can be remotely accessed by ACs during startup.
5. Active Probes (AP) located at the AC and a Traffic Monitor (TM) at the Internet Edge send traffic information to the Edge Controller (EC) so that bandwidth adjustments can be made at the Internet Edge or at the AC. These adjustments can be done either automatically or manually.
6. An Edge Controller (EC) that adjusts the settings in the AC to minimize congestion at the AC. The EC also adjusts the settings of the ER to minimize congestion among multiple enterprise customers connected to the Internet Edge. The EC uses APs located at the enterprise network to monitor congestion in the enterprise network. If the Enterprise AP exhibits congestion, the EC can increase the ACMaxRate parameter on the AC until there is no more congestion at the Enterprise AP. The EC also uses a Traffic Monitor (TM) located at the ISP Internet Edge Router to monitor congestion at the ISP Internet Edge. If the Edge TM indicates congestion, the EC can increase the EdgeMaxRate parameter on the Edge Router until there is no more congestion at the Edge AP.

By properly adjusting the parameters in the feedback control mechanisms of this invention, the amount of congestion on the system can be controlled and the amount of time the end user achieves their MaxRate and MinRate can be determined. It is a goal that the parameters of this invention be set so the QoS of a given end user can be defined as achieving the MaxRate at an arbitrarily high percent of the time such as greater than 95% of the time. This level of QoS can only be achieved if the system in uncongested.

These and other aspects of the present invention may be further understood by reference to accompanying drawings and the following detailed descriptions.

### BRIEF DESCRIPTION OF ILLUSTRATIONS

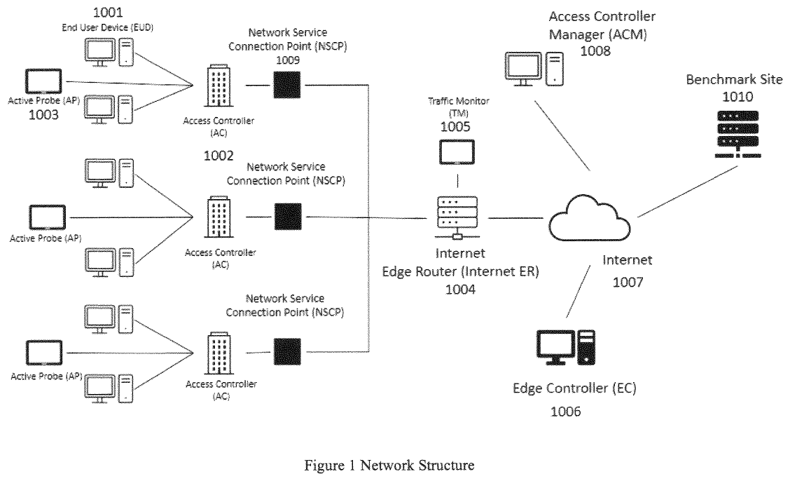

FIG. 1 shows the general structure of the network in an embodiment.

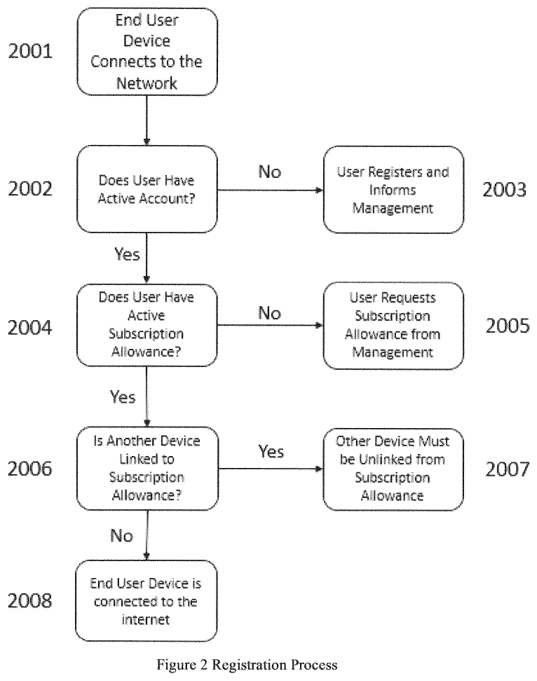

FIG. 2 demonstrates the registration process of any end user device to the network in an embodiment.

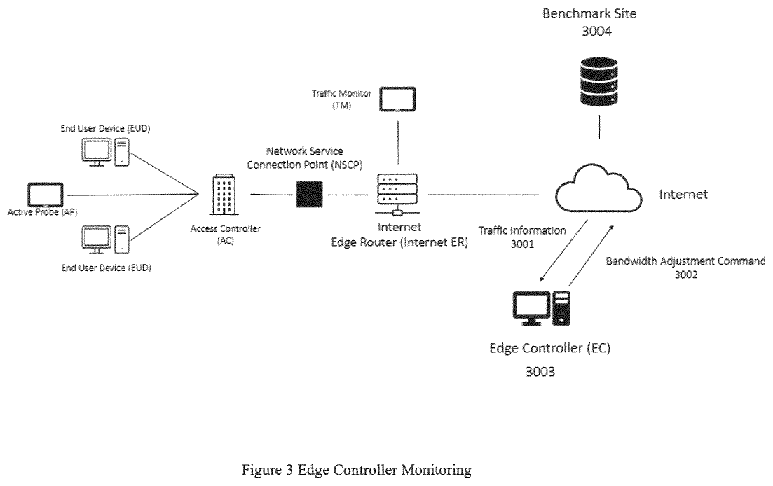

FIG. 3 is a diagram on the process of the FCM structure on the network in an embodiment.

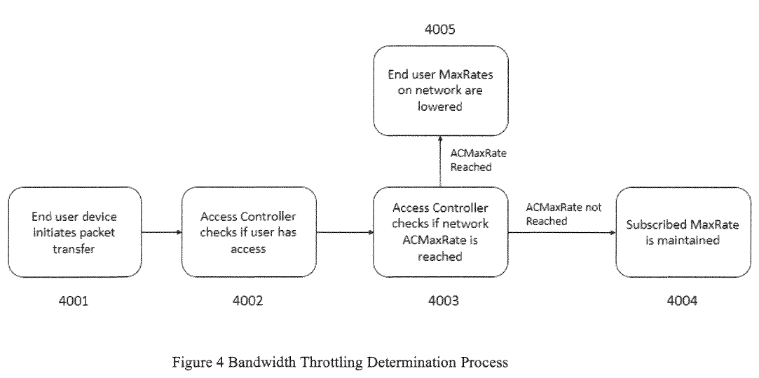

FIG. 4 is a flowchart for when Bandwidth Throttling goes into effect for any user.

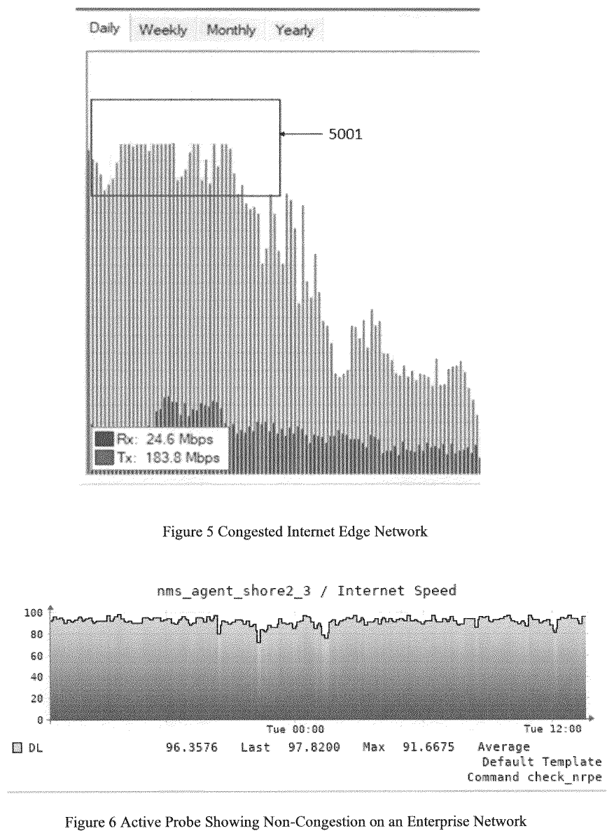

FIG. 5 is an example of reading from a Traffic Monitor (TM) showing congestion on an Internet Edge Network

FIG. 6 is an example of an Active Probe (AP) on the enterprise network detecting non-congestion on the enterprise network.

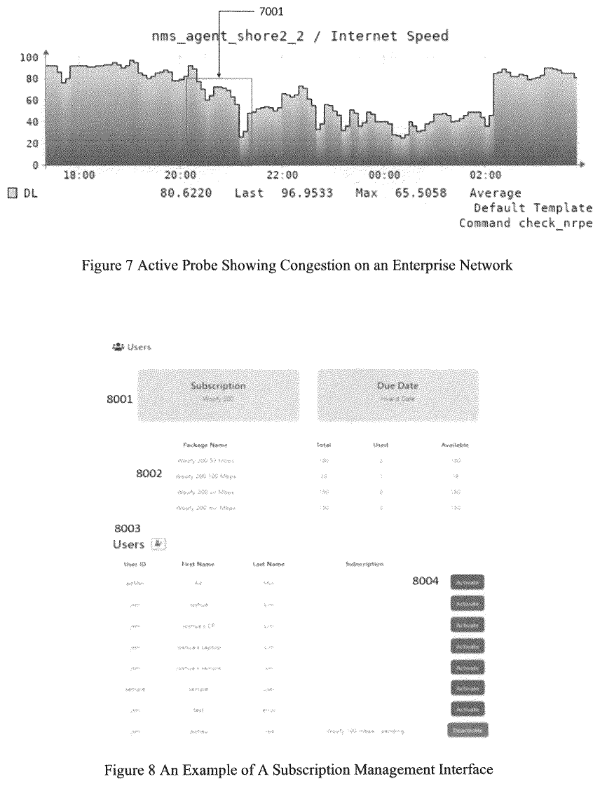

FIG. 7 is an example of an AP on the enterprise network detecting congestion on the enterprise network.

FIG. 8 is a sample of the user interface for a management page for the subscriptions in an enterprise in an embodiment.

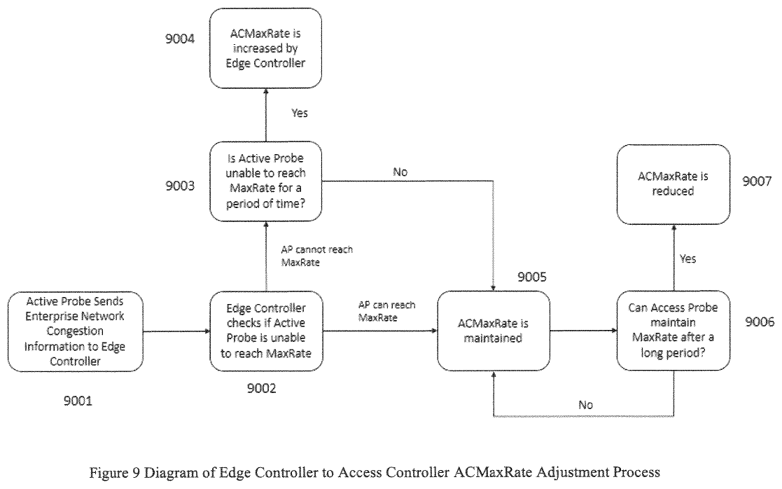

FIG. 9 is a diagram showing the adjustment process of the Edge Controller of the ACMaxRate on Access Controllers on the network.

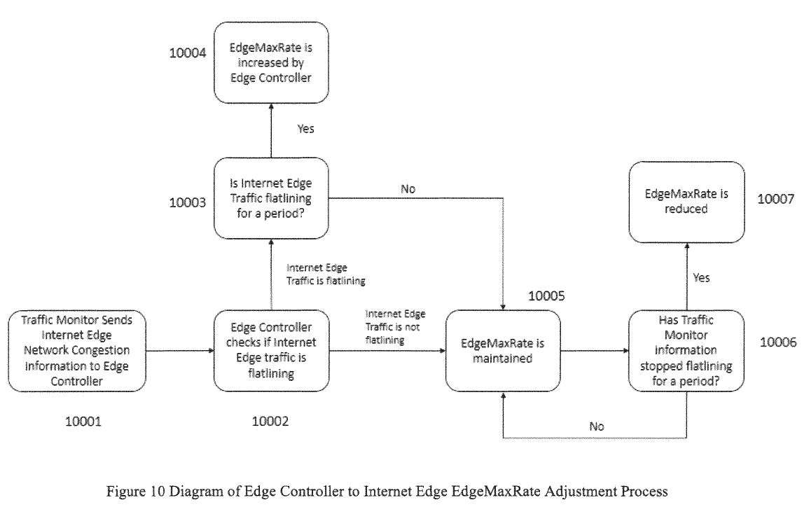

FIG. 10 is a diagram showing the adjustment process of the Edge Controller on the EdgeMaxRate on the Internet Edge of the network.

### DETAILED DESCRIPTION OF INVENTION

FIG. 1 shows an embodiment of the structure of the network with its most basic components. End User Devices (EUDs) 1001 refer to all devices connecting to a network, be they laptop, cellphone, or other device that utilizes the network for the transmission of data packets. All user devices are connected to one onsite AC 1002 that stores the parameters of the device alongside its subscription allowance information. Through the AC, traffic is sent to an ISP Internet Edge router device 1004 that aggregates the traffic and controls the flow of data packets from the network going out to the Internet. This device controls overall flow of traffic from the sites to the Internet 1007.

The ACs on the network are also connected to an ACM 1008 that manages the subscription allowance parameters and the end user device parameters. The ACM stores the subscription allowance parameters and the end user device parameters so that the AC can remotely load this information when the AC restarts. The AC does not store the subscription allowance parameters and the end user device parameters on non-volatile memory and only loads this information in runtime memory. This improves the scalability of the deployment of ACs while ensuring that all subscriber account information is consistent in the system. This can also minimize fraudulently provisioned connections because end user parameters stored on the AC can always be aligned with end user parameters stored on the ACM.

In the transfer of packet data through a network, a non-congested network is sufficient and necessary to ensure that end user devices on a network experience a sufficient QoS that is promised to them by the service provider. This QoS commitment can come in the form of a Minimum Rate (MinRate) wherein the system supplies the end user with enough resources to communicate on the network and allows packet transfer even during times of heavy network congestion. This is further improved by the application of a Maximum Rate (MaxRate) which dictates the maximum amount of resources that can be dedicated to a connection at any given time.

The present invention changes the point of bandwidth management within the enterprise from typically the Network Service Connection Point (NSCP) 1009, which is the device through which the enterprise connects to the Internet Edge Network, of the Enterprise Customer to the End User Device (EUD) of the enterprise user 1001. The NSCP is usually connected to Gateway Equipment that is installed at the Enterprise Customer network and connected to the Service Provider network. The EUD can be anything that requires access to the internet such as cellphones, laptops, or other smart devices. The service at the individual EUD is controlled via a per device subscription service that is managed by a management interface, such as is shown in FIG. 8 whose control may be under the service provider or the management of the enterprise. A single Enterprise subscription may contain multiple subscription allowances for multiple end users with different QoS settings.

The subscription service is checked the moment an enterprise end user device 2001 connects to the enterprise network. Upon connection, the end user is requested to log into their account 2002. If the user has no account, they must create one 2003 and inform the enterprise management so that an active subscription allowance can be assigned to the user device account. Once the account is accessed, the system will check if the user device has a subscription allowance that is assigned to the user device 2004. If there is no subscription allowance, then user must request a subscription allowance from the Enterprise management 2005. If the user has a subscription allowance assigned to their account, they must check if there is a device linked to their subscription allowance 2006. If there is none at the time, user can link his device to the subscription allowance and access the Internet 2008. If another device is already linked to the subscription allowance, then the other device must first be unlinked before another device can be linked to the subscription allowance 2007.

Management control of the network can be easily done via an application, an example of which has an interface that can be seen in FIG. 8. Primary functions of the application may include functions such as the ability to check which subscription allowances they have available 8001 and how many they have remaining of each type 8002. It also gives the user to ability to track which users on the network have their devices connected to the accounts 8003 and can activate, deactivate, or transfer subscription allowances as needed 8004. An embodiment of this management system may include other features, but the basic functionality should be the ability to designate subscription allowances to devices on the network and activate or de-activate subscription allowances. Processes done on the management interface are to ensure that accounts have access to the network and gives the enterprise management control over the capacity allocated to the users of the network.

The AC ensures that the capacity assigned to the enterprise network is not exceeded by its users. The FCM shown in FIG. 4 dictates an embodiment of a process to determine whether a user is going to receive the assigned maximum bandwidth (MaxRate) as dictated by their subscription. The user initiates a connection with a service 4001 and the AC checks if their machine has registered its details and has a working subscription 4002. It then checks the condition of the network's traffic at the AC interface, determining if the network is congested. The AC does this by checking if the traffic at the AC interface exceeds the ACMaxRate 4003. If AC traffic exceeds the ACMaxRate, the network is congested, 4005 it will lower the traffic rate of all the end user devices on the network until the MinRate. The MinRate can still provide connectivity to devices on the network at a reduced speed. The AC checks for congestion at a rate faster than the typical time constant it takes for devices on the network to respond to congestion. This is typically a few seconds for the Internet. If the AC finds that congestion has subsided, and the AC traffic is below the ACMaxRate 4004 the AC will set the traffic rate of all the end user devices on the network to the MaxRate. This first Feedback Control Mechanism (FCM1) ensures that end user devices will not experience contention of resources during peak busy hours on the enterprise network. End users will be able to access the Internet at their provisioned MaxRate. If the ACMaxRate is properly provisioned and set slightly greater than the average daily maximum busy hour traffic rate of the entire traffic of all users in the AC, then the end users will achieve their provisioned MaxRate most of the time, typically exceeding 90% of the time. The ACMaxRate can be set at a percentage, such as 25% higher than the average daily busy hour rate, to allow bursting to the ACMaxRate during abnormal peak traffic events.

As traffic flows through the AC 1002, information on congestion on the Enterprise Network is sent from an AP 1003 on the Enterprise Network to the EC 1006. If the EC 1006 monitors congestion at the AP 1003 the EC 1006 send a command to the AC 1002 to increase the ACMaxRate parameter until the AP 1003 no longer exhibits congestion. Similarly, the Edge Traffic Monitor TM 1005 connected to the Internet ER 1004 sends congestion information to the EC 1006. If the EC 1006 detects congestion at the TM 1005, the EC 1006 send a command to the ER 1004 to increase the EdgeMaxRate at the Internet Edge Router 1004 until the TM 1005 no longer indicates congestion. The EC 1007 implements a smoothing algorithm that discards temporary congestion reports and will only adjust the ACMaxRate at the AC 1002 or the EdgeMaxRate at the ER 1004 if the detected congestion is monitored over a long enough period. Typically, this might be 15 minutes or more. In case bandwidth usage decreases as monitored at the AC 1002, the ACMaxRate parameter may be reduced by the EC 1006. Likewise, if the bandwidth usage at the ER 1004 decreases, the Bandwidth Allocation at the ER 1004, the EdgeMaxRate parameter may be reduced by the EC 1006.

FIG. 7 shows the test results from an active probe (AP) on the enterprise when the enterprise network is congested. In this case, the AP has a subscription allowance set to a MaxRate of 100 Mbps. The AP regularly tests whether it can achieve its MaxRate by accessing a benchmark site on the Internet 3004. As can be seen on the highlighted region 7001 the benchmark performance dips well below the 80 Mbps mark, signifying that the AP can no longer get more than 80% of its allocated resources for a period. In 7001 each reading continues to decrease, up until the AP can no longer get higher than 30% of its allocated MaxRate. This diagram 7001 shows severe congestion.

During the operation of the network, AC 9001 the AP on the enterprise network connected to a particular AC, sends traffic information on the state of congestion of the enterprise network to an EC 3003. The EC checks if the AP test results show the network is congested 3001 by detecting whether the AP is unable to reach its MaxRate a predetermined percent of the time 9002, signifying that traffic on the AC has reached a point where the bandwidth throttling function of the AC on its users is in effect and users on the enterprise network are receiving below their MaxRate. The AC can be considered congested if for example the AP does not reach its MaxRate 90% of the time. Via a smoothing algorithm, the EC will discard temporary congestion data, and determine a course of action depending on whether the state of congestion has been maintained for a long enough period 9003. In the event that the state of congestion has only been attained for a single reading, the EC does not employ any bandwidth increase to the AC 9005, allowing the AC to continue its application of bandwidth throttling mechanisms to ensure that users on the enterprise network still have access to the internet. If the AP shows that traffic on the network continues to be congested an AC for a prolonged period, the EC will then increase the ACMaxRate 9004 of the AC, until it no longer needs to apply bandwidth throttling policies on the end users and allows them to achieve the subscriber allowance MaxRate. If the AP shows that traffic on the network is not congested for a prolonged period 9006, the EC may then decrease the ACMaxRate 9007 of the AC. The time constant of the second FCM2 where the EC adjusts the ACMaxRate is much longer than the first FCM1. This time constant may be in the order of several minutes. A smoothing function in the FCM2 can adjust the rate at which the EC can adjust the ACMaxRate. Adjusting the ACMaxRate ensures that during times of congestion on an enterprise network, additional bandwidth can be allocated to ensure the quality of the end user experience. Increasing the ACMaxRate will reduce throttling of the end user traffic allowing end users to reach their MaxRate.

Traffic on the ACs on the entirety of the network send traffic through the Internet ER, which acts similarly to an AC for the aggregate traffic of the network. The Internet ER has a downstream interface facing the enterprise customer side and an upstream interface connected to Tier 1 or Tier 2 ISPs. The Internet ER has a given capacity as well for handling traffic that passes through the entirety of the network. As such, it also has a capacity that can be reached on the downstream interface facing the enterprise customers before congestion on the aggregate network begins. FIG. 5 shows an example of the Traffic Monitor (TM) output on the Internet ER detecting that the ER is passing bandwidth at the full capacity of the ER 5001 for long periods of time. As shown in this example, the reading designating the traffic of the network on the graph is flatlining for a period, with each reading done every 5 minutes. This signifies that traffic on the edge network has reached the maximum amount it can based on its total allocated capacity. This Maximum capacity is defined as the EdgeMaxRate. We can, for example, consider a network to be fully congested if the graph continues to show a flatline for 6 consecutive 5 minute readings, meaning that the entirety of the network has reached its 100% capacity for 30 minutes on the enterprise facing side.

The Traffic Monitor on the Internet ER then sends the traffic information on the state of congestion at the ER to the EC 10001. Congestion on the ER occurs when the ER has reached its EdgeMaxRate 10002, for an extended period, signifying that during the period, ACs on the downstream network of the ER can no longer receive additional bandwidth to allocate to enterprise users regardless of the state of congestion at the AC. As such, congestion at the ER can cause problems across the entirety of the service provider network as it signifies that there will be a contention of resources for all ACs on the network, and since it is possible to achieve this without the AC traffic reaching the ACMaxRate, FIG. 4 and FIG. 9 processes will not take effect. As such, users on the network will continue to contend for resources, and the FCMs in place will not throttle traffic, thus preventing some users from reaching their set QoS parameters for an extended period. As such, it is necessary for the EC to apply bandwidth adjustment at ER to achieve non-congestion on the network.

Once traffic information has been sent to the EC, the third FCM3 on EC determines if the traffic information from the TM on the ER shows congestion. If none, then the EdgeMaxRate is maintained 10005. If congestion is detected 10003, a smoothing algorithm discards temporary congestion data, and only considers the network to be in a state of congestion if the traffic on the aggregate networks continues to match the EdgeMaxRate for a long enough period. Detecting congestion in the ER can typically take tens of minutes. If it is determined that the network has been congested for a long enough period 10004, the EC sends a command to increase the EdgeMaxRate to allow more bandwidth to be allocated to the AC on the network, thus allowing them to reach their ACMaxRate and allowing the FCMs on the end users and the ACs to operate as intended. Traffic information from the TM continues to be passed to the EC to check if flatlining continues on the Internet Edge network 10006, and if it is monitored that flatlining on the Internet Edge network traffic has ceased for a period, then the EC lowers the EdgeMaxRate of the ER 10007.

It should be noted that the amount of resources that can be allocated to the ER is dependent on the contract between the ISP and the Tier 1 and Tier 2 ISPs that provide the connection to the internet to the ER. The adjustments are assumed to be possible based on contracts such as “per-use-basis” agreements or “peak bandwidth” agreements to allow the ISPs to adjust supply to the rest of the network.

Information from the monitoring process can also be used to improve the network during times where congestion is not seen on enterprise networks. Since congestion is a dependent on the demand of resources versus their availability, certain sites may not reach a point of congestion as their application may not be as heavy as other sites. As such, the service provider can choose to control the ACMaxRate on different sites, such that it can reallocate resources to other sites while simultaneously ensuring that the original site QoS is not impacted negatively.

As can be seen in the prior examples regarding the FCMs, to ensure quality service for end user devices, non-congestion at all points of the network needs to be maintained by the FCMs. To represent and simplify this, we denote the amount of bandwidth used by an end user device on the network during the busy hour as User Traffic. Most of the time, the User Traffic of any end user device is going to be lower than its MaxRate. As such, this means that multiple devices can run on the network simultaneously even during the busy hour without congestion occurring, as the amount of resources being demanded by each device is much lower than its assigned subscription. So long as this is fulfilled, the network can be considered as being in a state of non-congestion, and at any time should a user demand more bandwidth to accomplish a process, the network will allow them to use more resources up till their subscriber allowance MaxRate.

We denote the Average User Traffic of each user at the time of maximum traffic generated at the Busy Hour as Tᵤₛₑᵣ and the maximum bandwidth capacity of the enterprise as allowed by the AC on site as Cₑₙₜ. The Cₑₙₜ must be greater than the maximum traffic generated during the Busy Hour. As such, non-congestion is achievable when the summation of all Tᵤₛₑᵣ is less than the capacity of the enterprise, i.e.,

$$\sum {T}_{user} < {C}_{ent} \qquad Equation 1$$

### Where:

Tᵤₛₑᵣ=Traffic generated during busy hour per user

Cₑₙₜ=ACMaxRate of the AC

Similarly, the traffic coming from all enterprise ACs during the Busy Hour must be lower than total capacity of the Internet ER. If the Internet ER capacity, as denoted by C_{IE}, is breached by simultaneous high traffic coming from enterprise sites, then regardless of whether a site has reached its Cₑₙₜ, end users in the enterprise may experience congestion. This is because while theoretically the individual enterprise may have a greater available capacity, all resources that can be supplied by the Internet ER are currently being consumed by other enterprises on the network.

Capacity of the enterprise network, works in a similar manner to the MaxRate given to end users on the network. Typically, an enterprise network will reach its maximum capacity every day. This occurs during the busy hour. The busy hour usually occurs at the same time for enterprise users, during working hours. Therefore, it is good practice for service providers to provision capacity for enterprises such that the aggregate sum of their maximum capacity is less than the actual capacity of the Internet ER.

As such, we can denote the maximum Controller Traffic of each enterprise during the Busy Hour T_{Ent} and the overall capacity of the Internet Edge as C_{IE}. The total capacity of the Internet Edge must then be greater than the aggregate sum of the Controller Traffic during the Busy Hour. This relationship is shown by,

$$\sum {T}_{Ent} < {C}_{IE} \qquad Equation 2$$

### Where:

Tᵤₛₑᵣ=Traffic generated during busy hour per AC

Cₑₙₜ=EdgeMaxRate of the Internet ER

Both equations 1 and 2 must remain true to ensure decongestion on any point on the network and ensure an agreed upon QoS to all end users. Should equation 1 no longer hold true, traffic on specific ACs will reach a point of congestion, and EUDs on certain sites will suffer network performance issues. Should equation 2 no longer hold true, traffic on the entirety of the aggregate network will reach a point of congestion. As such, the FCMs on the network aim to maintain what is stated by the two equations.

Similarly should the service provider see that users on the network are not exceeding the bandwidth and that there is room to allow them to increase capacity, then potentially they can develop subscription packages with higher MinRate or MaxRate for users on the network to improve their overall experience. This will also allow the service provider to plan for future expansions by using Busy Hour Traffic information to understand the trends of enterprises and to plan the infrastructure and future developments around accommodating those.

The present invention is described above with reference to specific embodiments mentioned above. However, this invention can be executed with variations and modifications. It is therefore intended that the appended claims below shall not be limited to the embodiment introduced above.

What we now claim are as follows:

1. A subscription-based system that designates the individual devices such as laptops, cellphones, desktop computers, or any device that uses a connection to the Internet as the point of bandwidth management rather than the NSCP of the Enterprise Network. The system is also responsible for managing traffic onsite to ensure a certain level of QoS for users on the Enterprise Network. The system comprises of several components as follows:
a) A subscription management system that allows for a designated manager to control the number of EUDs permitted to connect to the network as well as designate the MaxRate each device can reach while connected to said network and the MinRate that each device is ensured to attain at all times. The MaxRate and MinRate combined define an end device Quality of Service (QOS) parameters.
b) An AC device at each Enterprise Network that contains the device parameters along with the subscription allowance information associated with each device, and grants access to devices to the Internet based on recorded subscription allowance parameters. AC enforces bandwidth management policies when traffic on the network has exceeded its ACMaxRate, lowering the MaxRate of EUDs on the network to their MinRate.
c) An ACM that stores the data of each access controller on the network, including subscriber allowance data if an access controller on the network should require bandwidth adjustment or need to have its subscriber list update, the access controller manager is able to adjust the settings on a specific device.
d) An Internet ER that has a downstream interface facing the Enterprise Networks and one connected to Tier 1 or Tier 2 ISPs. The Internet ER acts as a gateway device for ACs on the network to connect to the wider Internet.
e) Active Probes (AP) connected to the enterprise network and a Traffic Monitor (TM) on the Internet Edge Router that can detect when the networks are congested and send this information to the EC.
f) An EC that receives traffic data from AP on the enterprise network and a TM on the Internet Edge network. Using feedback from the APs and TM, the EC adjusts settings for ACs and ER to minimize the congestion on the enterprise network and the Internet Edge network.

2. A system for claim 1 that requires the customer to sign into the enterprise network via a portal web page.

3. A system for claim 1 that allows users to sign in via the use of a Quick Response (QR) code.

4. A system for claim 1 that allows users to register and be authenticated on the system.

5. A system for claim 1 that allows users to sign in via the use of an application program.

6. A system for claim 1 that allows users to be registered in bulk in the system via a batch upload process.

7. A method of claim 1 wherein the AC Manager and EC are housed in the same unit.

8. A method of claim 1 wherein a user is allowed to change subscription allowances freely without unused subscription expiring while no device is using it

9. A method of claim 1 wherein an end user device can be disconnected to the network and immediately reconnect when able without the need for undergoing any subscription process that was already done prior if the device still has an active subscription according to the AC data.

10. A method for determining the application of bandwidth management on end user devices on the network, the method comprising steps of:
a) Determine the state of congestion on the AC through checking the equation 1:
$$\sum {T}_{User} < {C}_{Ent}$$
Where:
T_{User}=Traffic of each EUD on the AC network
C_{Ent}=Capacity of the AC on the Enterprise Network
b) If ΣT_{User}<C_{Ent} is true, the Enterprise Network is considered non-congested and bandwidth management does not occur on the AP.
c) If ΣT_{User}<C_{Ent} is false, the AC bandwidth management policies apply, and traffic is throttled, reducing the subscription allowance MaxRate of EUDs until their subscription allowance MinRate.
d) If ΣT_{User}<C_{Ent} becomes true after a reading of false, bandwidth management policies no longer apply and EUDs are allowed to connect with the MaxRate as dictated by their subscriber allowance parameters.
e) FCM continues to run to ensure that during times of congestion on the enterprise network, all users still have available resources for accessing the Internet, albeit at a reduced capacity until congestion subsides or other systems on the network apply bandwidth adjustment.

11. A method of determining the state of congestion on an AC and the application of bandwidth management on the AC on the enterprise, the method comprising of the steps:
a) The AP tests for congestion on the enterprise network by regularly checking if it can achieve its MaxRate when accessing a benchmark site on the Internet and sends the congestion test result for the enterprise network to the EC,
b) When the EC detects congestion at the AP if, for example, the AP does not reach its MaxRate 90% of the time, the EC adjusts the ACMaxRate parameter until the AP no longer shows congestion and the following equation is met:
$$\sum {T}_{User} < {C}_{Ent}$$
Where:
Tᵤₛₑᵣ=Traffic of each EUD on the AC network
Cₑₙₜ=Capacity of the AC on the Enterprise Network
c) FCM continues to run to ensure that during times of congestion on the enterprise network, the ACMaxRate can be increased to allocate additional bandwidth to the customers on the enterprise network and ensure that users on the network achieve their provisioned MaxRate an arbitrarily high percentage of the time.

12. A method of determining the state of congestion on the Internet ER and the application of bandwidth management on the ER, the method comprising of the steps:
a) The TM on the Internet ER sends traffic information of the Internet Edge network to the EC; the EC determines the state of congestion on the Internet ER by checking for flatlining on the TM traffic information.
b) When the EC detects flatlining in the TM for a predetermined amount of time such as 6 consecutive 5 minute sample intervals, the EC increases the capacity at the Internet Edge by increasing the EdgeMaxRate until the TM no longer indicates congestion in the Internet Edge.
c) Non congestion at the Internet Edge is achieved when the following equation is true:
$$\sum {T}_{Ent} < {C}_{IE}$$
Where:
T_{Ent}=Traffic of an AC on the network
C_{IE}=Capacity of the Internet ER on the Enterprise facing side
d) FCM continues to run to ensure that the Internet Edge network always remains decongested, ensuring that end users on the enterprise networks achieve their provisioned MaxRate given that the enterprise network is not congested.
